(19) United States
(12) Patent Application Publication
(10) Pub. No.: US 2013/0107322 A1
(43) Pub. Date: May 2, 2013

(54) IMAGE FORMING APPARATUS

(71) Applicant: Sharp Kabushiki Kaisha, Osaka (JP)

(72) Inventors: Kazumasa TONAMI, Osaka (JP); Takeshi NAKAMURA, Osaka (JP)

(73) Assignee: SHARP KABUSHIKI KAISHA, Osaka (JP)

(21) Appl. No.: 13/662,527

(22) Filed: Oct. 28, 2012

(30) Foreign Application Priority Data
Nov. 1, 2011 (JP) 2011-240309

(51) Int. Cl. G06F 3/12

(52) U.S. Cl. CPC G06F 3/1296
USPC 358/1.15

(57) ABSTRACT

An image forming apparatus includes a paper discharge section sequentially accumulating printed matters allowing them to be taken out freely; a memory section storing the print jobs performed by the image forming section and information on terminals having ordered runs of the print jobs associating the former with latter; a display section displaying a history of respective print jobs stored by the memory section as a first display content; an operating section accepting a selection of any print job from the history of the respective print jobs displayed on the display section; and a control section reading out from the memory section information on a terminal corresponding to said any print job of which selection has been accepted by the operating section and therewith transmitting a predetermined message to a contact address of a user who has ordered a run of said any print job using the terminal.

### CROSS REFERENCE

This Nonprovisional application claims priority under 35 U.S.C. §119(a) on Patent Application No. 2011-240309 filed in Japan on Nov. 1, 2011, the entire contents of which are hereby incorporated by reference.

### BACKGROUND OF THE INVENTION

The present invention relates to an image forming apparatus provided with a display section that displays a history of print jobs performed in the past when a printed matter is missing from a paper discharge section.

In offices, it is often the case that an image forming apparatus is shared by a plurality of users so as to restrain costs and the installation area. In such an image forming apparatus, printed matters of a plurality of users are accumulated in a paper receiving tray when a series of print jobs of the plurality of users are performed or in like cases.

In the case where the printed matters of the plurality of users are accumulated in the paper receiving tray, however, there is a possibility that a user mistakenly takes away the printed matter(s) of the other user(s) together with the printed matter of his/her own, so that the printed matter(s) can be missing from the paper receiving tray. In such a case, in order to find the printed matter, the user whose printed matter is missing has had to ask other users about the missing printed matter; and thus there has been a problem that such a task is troublesome.

Then, an image forming apparatus has been proposed that is capable of preventing the printed matter from being taken away by any of other users (refer to Japanese Patent Unexamined Publication No. 2001-239720 bulletin). The image forming apparatus is provided with boxes each with a cover in the paper discharge section, permitting users each to specify a box in which to receive the printed matter for each. Also, the cover of the box can be locked by a password. Accordingly, by assigning a receiving destination of the printed matters of their own to each user, only the user who set the password can take out the printed matter without causing the printed matters of the other users to be mixing within. This enables the printed matter to be prevented from being missing.

However, although the image forming apparatus described in the Japanese Patent Unexamined Publication No. 2001-239720 bulletin makes it possible to prevent the missing of the printed matter, it requires as many boxes each with a cover as the number of users to share the use of the apparatus with installed on a side face of its main body. On that account, there has arisen a problem that the apparatus upsizes and that the installation area increases.

Therefore, the present invention is directed to providing an image forming apparatus that facilitates an inquiry task to users of the image forming apparatus at the time when the printed matter is missing while not causing the apparatus to upsize.

### SUMMARY OF THE INVENTION

An image forming apparatus of the present invention includes an image forming section, a paper discharge section, a memory section, a display section, an operating section and a control section. The image forming section performs each print job ordered by a plurality of users, and produces each printed matter of each print job. The paper discharge section sequentially accumulates each printed matter the image forming section has produced, and the accumulated printed matters can be taken out freely. The memory section stores each of the print jobs the image forming section has performed and information on each of the terminals which are connected to the memory section through a network and from which a run of each of the print jobs has been ordered, associating the former with the latter. The display section displays a history of the respective print jobs the memory section stores as a first display content. The operating section accepts a selection of any print job from the history of the respective print jobs displayed on the display section. The control section reads out from the memory section information on a terminal corresponding to the said any print job of which selection the operating section has accepted, and transmits a predetermined message making use of a contact address of a user as destination who has ordered a run of the said any print job using the terminal.

With this configuration, by operating the operating section and selecting a print job from the history of the print jobs displayed on the display section, a user can transmit the predetermined message to the contact address of the other user who has ordered the run of the selected print job. This allows a user to make inquiries about the printed matter by operating the operating section and selecting the print job of which run the other user who may possibly have taken away the printed matter has carried out, when the accumulated printed matters in the paper discharge section have been taken out improperly and the printed matter of the user is missing. Therefore, when the printed matter is missing, an inquiry task can be carried out easily to the other users using the image forming apparatus. Also, with this configuration, since it is not necessary that the image forming apparatus is provided with a covered box device or the like, the apparatus will not upsize.

In the above-mentioned invention, the predetermined message that is transmitted to the contact address of the user as destination includes a first message to examine whether or not a printed matter has been properly taken out from the paper discharge section.

With this configuration, transmitting the message to examine whether or not the printed matter has been taken out properly from the paper discharge section when the printed matter is missing from the paper discharge section makes it possible to get the user who has received the message to examine whether the missing printed matter has been taken out mistakenly. Thus, it becomes very likely that the missing printed matter can be discovered.

In the above-mentioned invention, the predetermined message that is transmitted to the contact address of the user as destination further includes a second message requesting that the printed matter is to be returned when the printed matter has been taken out improperly.

With this configuration, when the printed matter is missing from the paper discharge section, it is possible to get the user who has taken out the missing printed matter to return the printed matter. Therefore, the labor of going to the user for the printed matter who has taken away the missing printed matter can be saved.

In the above-mentioned invention, the second message is a message requesting that the printed matter is to be returned back to the paper discharge section when the printed matter has been taken out improperly.

When a return destination of the printed matter taken away mistakenly is the paper discharge section, the user can get it returned without constraint.

In the above-mentioned invention, the predetermined message that is transmitted to the contact address of the user as destination further includes a third message describing information on identification of a user.

With this configuration, notification of the information on identification of the user whose printed matter is missing makes it possible to get the printed matter returned directly to the user under certain circumstances.

In the above-mentioned invention, the predetermined message transmitted to the contact address of the user as destination includes a fourth message stating that the printed matter has been returned back to the paper discharge section. Moreover, the operating section is provided with a function to accept an input of return-confirmed information that the printed matter has been returned back to the paper discharge section after completion of transmission of the first message; and then the control section transmits the fourth message to the destination if the return-confirmed information is inputted at the operating section.

With this configuration, when the missing printed matter is returned back to the paper discharge section and if the return-confirmed information is inputted, the fourth message stating that the printed matter has been returned back to the paper discharge section is transmitted to the user whose printed matter was missing. Accordingly, the user whose printed matter was missing can get the printed matter surely without frequently examining whether the printed matter has been returned back to the paper discharge section.

In the above-mentioned invention, if the control section receives a reply to the first message after completion of the transmission of the first message, the display section displays the reply.

With this configuration, since the reply to the first message is displayed, the user whose printed matter is missing can examine whether or not the other user who sent the message has taken away the printed matter mistakenly.

In the above-mentioned invention, the number of said any print jobs capable of being accepted by the operating section is plural.

With this configuration, because a plurality of the print jobs can be chosen at the operating section from the history of the print jobs, it is not necessary to transmit messages many times, so that the inquiry task can be carried out effectively.

In the above-mentioned invention, when a missing print job of which printed matter is missing from the paper discharge section is selected by the operating section from the history of the respective print jobs the memory section stores, and therewith if the control section extracts one or more past print jobs satisfying printing conditions that concern the missing print job, the display section further displays the one or more past print jobs as a second display content.

With this configuration, if the missing print job is chosen, the one or more print jobs performed in the past are extracted based on the printing conditions that concerns the print job, and are displayed on the display section. This makes it possible to extract one or more print jobs of which runs were ordered by users who are very likely to have taken away the missing printed matter. Thus, when transmitting the message inquiring about the missing printed matter, the user can make a selection of one or more print jobs more simply and more easily.

Included in the above-mentioned invention is a detecting section that detects whether or not an accumulation of each printed matter is present in the paper discharge section. If the operating section accepts the selection of the missing print job, the control section extracts one or more print jobs from the memory section based on the output of the detecting section that correspond to printed matters accumulated in the paper discharge section ahead of and behind the missing printed matter produced by the missing print job, and then the display section displays the one or more extracted print jobs.

With this configuration, the other printed matters accumulated together with the missing printed matter in the paper discharge section can be limited. Therefore, users who are likely to have taken away the missing printed matter can be narrowed down.

In the above-mentioned invention, one or more destinations that are the contact addresses of the users who have ordered the runs of the print jobs using the terminals are mail addresses of the users or display screens of the terminals the users have used.

Transmitting a mail with a message to the one or more users who are likely to have taken away the printed matter or causing the display screens of the terminals the users use to display each a message makes it possible to get the users to read the message surely.

The present invention makes it possible to make inquiries about a missing printed matter when the printed matter is missing from the paper discharge section. Besides, it is effective in preventing the apparatus from upsizing.

### BRIEF DESCRIPTION OF THE DRAWINGS

FIG. 1 is an example of a configuration diagram of a printing system including an image forming apparatus according to an embodiment of the present invention.

FIG. 2 is an external view of the image forming apparatus.

FIG. 3 is a block diagram of the image forming apparatus.

FIG. 4 is an external view of a panel unit.

FIG. 5 is a flow chart explaining an inquiry process of a missing printed matter.

FIG. 6 is a diagram showing an example of a job history displayed on a display section.

FIG. 7A-F are diagrams showing a transition of displays in the course of operations to carry out an inquiry process about a missing printed matter.

FIG. 8A is a diagram showing an example of a mail to examine whether or not the missing printed matter has been taken away; and

FIG. 8B is a diagram showing an example of a monitor screen of a computer on which a pop-up message to examine whether or not the missing printed matter has been taken away is displayed.

FIG. 9 is a diagram showing a relationship between the time when print jobs were carried out and printed matters a detecting section detected.

FIG. 10 is a flow chart explaining a process by a control section.

FIG. 11 is a table showing printing conditions of the missing printed matter and values for weighting.

### DETAILED DESCRIPTION OF THE INVENTION

Hereinafter, an example is explained in which the present invention is applied to a digital multifunctional apparatus installed in an office.

[Configuration of an Image Forming System]

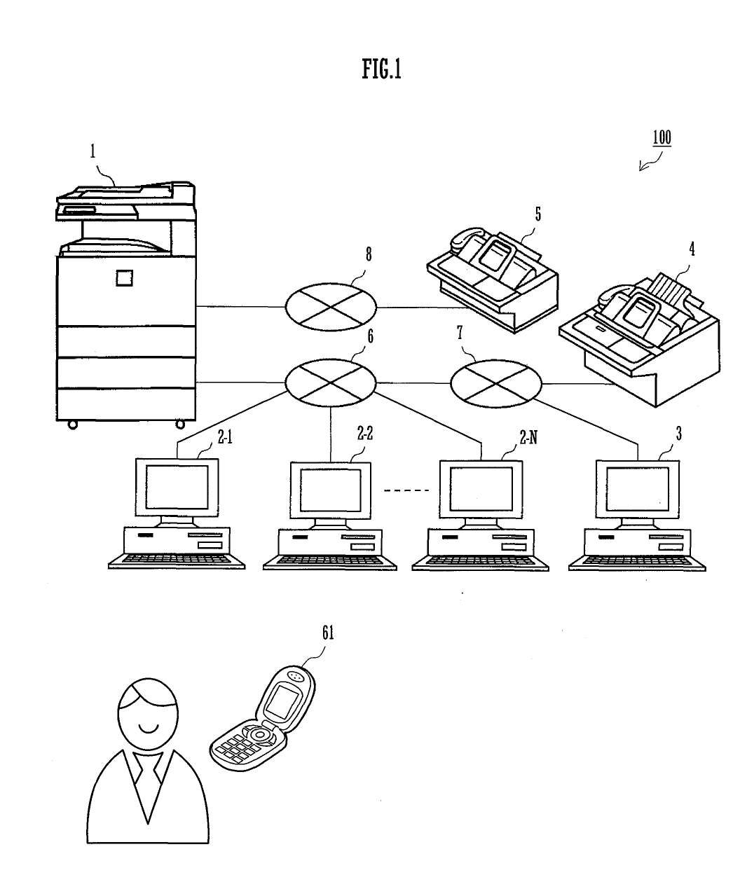

As shown in FIG. 1, an image forming system 100 includes a digital multifunctional apparatus (merely referred to as multifunctional apparatus, hereinafter) 1, N units of computers 2-1 through 2-N, a computer 3, an Internet Fax apparatus 4, a Fax machine 5 and a mobile phone 61.

The multifunctional apparatus 1 and the computers 2-1 through 2-N are connected to a LAN 6 laid in the office. The computer 3, the Internet Fax apparatus 4 and the LAN 6 are connected to the Internet network 7. Also, the multifunctional apparatus 1, the Fax machine 5 and the mobile phone 61 are connected to the dial-up line network 8.

[Configuration of an Image Forming Apparatus]

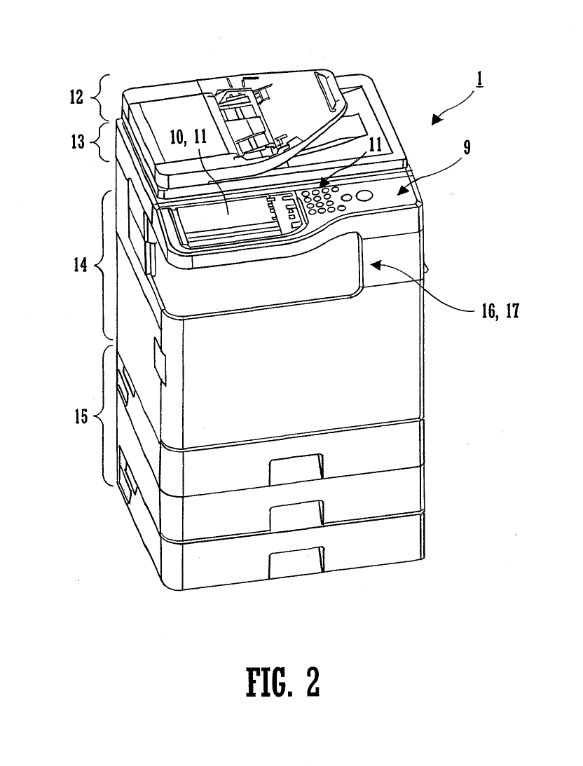

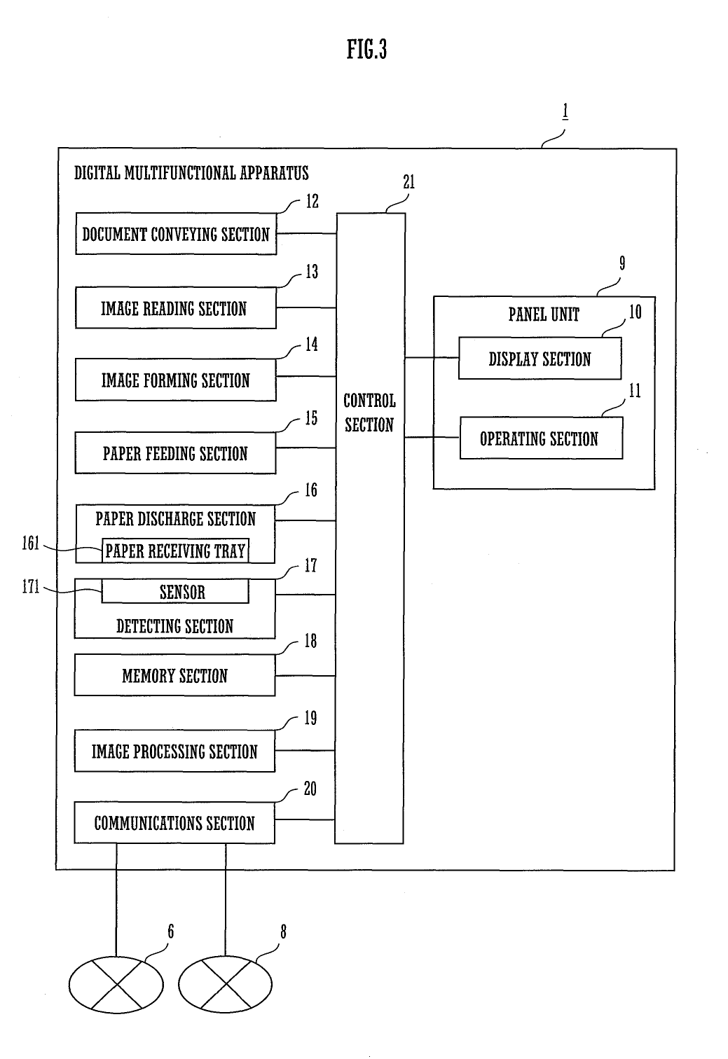

As shown in FIG. 2 and FIG. 3, the multifunctional apparatus 1, being of intra-body discharge type, is provided with a panel unit 9 on the near side on a top surface of a main body. In the multifunctional apparatus 1, installation of such a box with cover as described in the above-mentioned patent literature is unnecessary. The panel unit 9 includes a display section 10 and an operating section 11. Also, the multifunctional apparatus 1 is provided with a document conveying section 12, an image reading section 13, an image forming section 14 and a paper feeding section 15 in this order toward the direction from the upper part to the lower part of the main body. Additionally, under the image reading section 13 and the panel unit 9 are installed a paper discharge section 16 and a detecting section 17. The paper discharge section 16 includes a paper receiving tray 161 accumulating printed matters the image forming section 14 produces. Also, the detecting section 17 includes a sensor 171 detecting the presence of the printed matter(s) accumulated in the paper receiving tray 161. Further, the multifunctional apparatus 1 includes a memory section 18, an image processing section 19, a communications section 20 and a control section 21 in the main body.

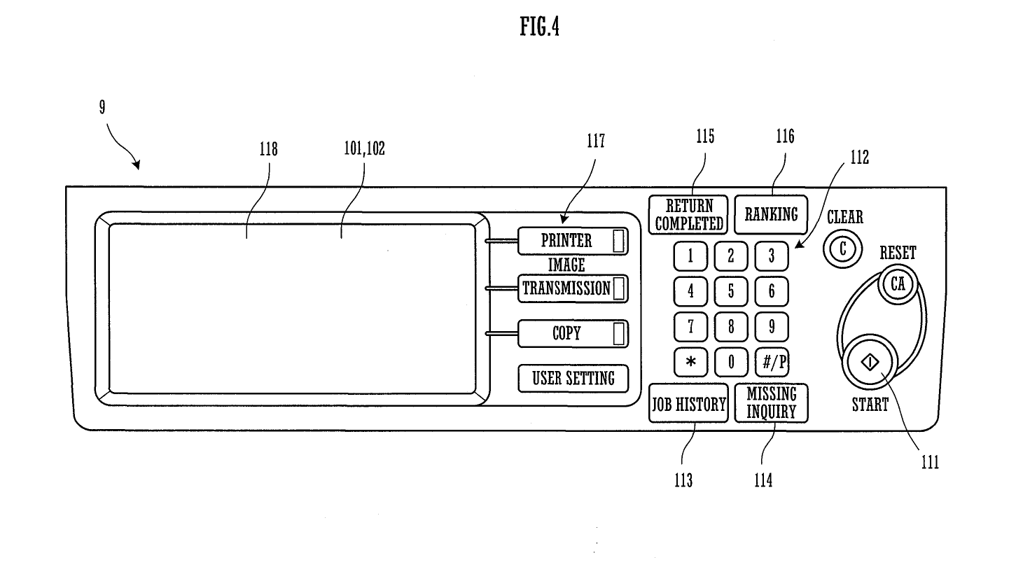

As shown in FIG. 4, the display section 10 includes a display panel 101 having a LCD (liquid crystal display) drive circuit and a liquid LCD panel, and a back light unit 102 having a LED drive circuit and a plurality of LED's for use to the back light.

The operating section 11 includes a plurality of operating buttons such as a start button 111, a set of numeric keys 112, a job history button 113, a missing inquiry button 114, a return-completed button 115, a ranking button 116, a function-select button 117, and a touch panel 118.

The panel unit 9 is made up of the back light unit 102, the display panel 101 and the touch panel 118 laminated in this order.

The multifunctional apparatus 1 is one embodiment of an image forming apparatus according to an embodiment of the present invention, and is provided with a print function, a copy function and a fax function.

The print function is a function that performs printing based on print jobs the multifunctional apparatus 1 receives from the computers 2-1 through 2-N to produce printed matters.

The computers 2-1 through 2-N each have a built-in printer driver, and each generate a print job to cause the multifunctional apparatus 1 to print document data and/or image data according to an operation of each user. Then, the computers 2-1 through 2-N each transmit the print job to the multifunctional apparatus 1 through the LAN 6.

The print job includes information on identification of the computer such as user ID and IP address, and information on various kinds of settings for printing and the like, in addition to the data to print.

The control section 21 of the multifunctional apparatus 1, upon the communications section 20's receiving a print job through the LAN 6, causes the image data included in the print job to be output to the image processing section 19. Also, the control section 21 changes settings of the image processing section 19 and the image forming section 14 based on the settings for printing included in the print job.

When color image data are inputted, the image processing section 19 separates the color image into monochromatic images of yellow, magenta, cyan and black, and outputs the respective monochromatic images to the image forming section 14.

The image forming section 14 forms single color toner images based on the inputted monochromatic images, and generates a color toner image by superimposing the respective single color toner images. Then, the image forming section 14 transfers the color toner image onto a paper sheet conveyed to a transfer position by the paper feeding section 15, and subsequently causes a fuser unit to fix the color toner image on the paper sheet by. The paper discharge section 16 discharges a printed matter that is the paper sheet on which the color toner image has been fixed to the paper receiving tray 161 of the paper discharge section 16. The paper receiving tray 161 can accumulate a plurality of printed matters, and users can freely take out accumulated printed matters.

The multifunctional apparatus 1, on performing a printing, can identify a user who ordered a run of the print job from a user ID and/or an IP address of an origin of transmission of the print job that are included in the print job.

The copy function is a function that reads an image of a document at the image reading section 13 and produces a printed matter copying the document based on the print job accepted at the operating section 11.

The control section 21, upon detecting that the operating section 11 has accepted an operation of copying which is a print job and that the document is placed either in the document conveying section 12 or on a document table of the image reading section 13, starts a copying process. The control section 21, upon accepting operations below, for example, at the operating section 11, causes the image forming section 14 to produce a printed matter under a condition that depends on the accepted operation.

In the multifunctional apparatus 1, for copying, inputting a user ID is required first. This is to identify a user who has ordered a run of the copying when a missing printed matter occurs, as described below. Among methods for inputting a user ID are there one in which a user operates the operating section and inputs it manually, and another one in which a card that has a registered user ID on it and has been delivered beforehand to the user is read by a card reader not illustrated when a copying is made, etc..

The control section 21, upon the copy function's being selected through an operation of the function-select button 117 after the user ID has been inputted, and subsequently upon accepting the settings of a copying condition made through an operation of the touch panel 118 and/or the set of numeric keys 112, sets the accepted copying condition onto the image processing section 19 and/or the image forming section 14. Then, the control section 21, upon accepting an operation of the start button 111, causes the document placed in the document conveying section 12 to be conveyed to the document table and then to be moved to the image reading section 13. The image reading section 13 reads an image of the document having been conveyed by the document conveying section 12 or the document placed on the document table.

The image reading section 13 outputs data of the read image to the image processing section 19. The multifunctional apparatus 1 performs, from this onward, the same process as when the print function is selected, and discharges a printed matter to the paper receiving tray 161 of the paper discharge section 16.

With the multifunctional apparatus 1, if a copying has been made, a user who ordered the run of the print job can be identified from the user ID that was inputted first.

The fax function is functions to transmit to and receive from the Internet Fax apparatus 4 or the Fax machine 5 image data. Of these, it is the function to receive image data that relate to the present invention.

The control section 21, upon the communications section 20's receiving fax data as a print job transmitted from the Internet Fax apparatus 4 or the Fax machine 5, outputs the fax data to the image processing section 19. The fax data include information such as information on origin of transmission, information on destination of transmission (where to send), and various kinds of settings for printing, in addition to the image data. The multifunctional apparatus 1 performs, from this onward, the same process as the print function, and discharges a printed matter to the paper receiving tray 161 of the paper discharge section 16.

With the multifunctional apparatus 1, if a fax has been made, a user who ordered the run of the print job can be identified from the information on origin of transmission or the information on destination of transmission included in the fax data. In other words, if the information on destination of transmission includes a user name, a user who has taken out the printed matter from the paper receiving tray 161 can be identified from the user name. Also, even when a user name is not included in the information on destination of transmission (where to send), a user who has received a fax (printed matter) can be identified from the information on origin of transmission, since the other party (origin of transmission) from whom the user receives fax is usually limited. For example, when there are three users relating to the origin of transmission of the fax, possibility can be narrowed to the three people.

The multifunctional apparatus 1, on accepting a run order of a print job and then carrying out a printing, copying or fax, stores in the memory section 18 information on the print job that was carried out. Information to store in the memory section 18 includes, for example, kind of the print job, receipt number of the print job, ID of user who ordered run of the print job, date and time when the print job was carried out, number of sheets printed, output paper size, IP address of instrument that received the print job and so forth.

Also, in the multifunctional apparatus 1, IP addresses of the computers 2-1 through 2-N that are connected to the LAN 6, ID's of users who use the computers 2-1 through 2-N, and information (contact address) on terminals that notify users who use the computers 2-1 through 2-N of a message have been registered beforehand associating them with each other. The memory section 18 stores these pieces of information. Here, the terminals that notify users of a message can be any ones that the users usually use and enable the users to check a message in letters or sound. For example, they may be computers 2-1 through 2-N, and/or mobile devices such as mobile phones 61 the users use.

The information (contact address) on the terminal may be address of mail that can be checked on computer, address of mail that can be checked on mobile phone user uses, number of the mobile phone user uses or the like. Or, it may be IP address of a computer when dedicated software for message indication use is installed in the computer.

In the multifunctional apparatus 1, the control section 21 detects with the sensor 171 whether or not an accumulation of the printed matter(s) is present in the paper receiving tray 161, as mentioned above. Then, in the memory section 18 the control section 21 stores the periods during which the printed matters were accumulated in the paper receiving tray 161. This is to narrow down to one or more print jobs which the missing printed matter is likely to be mixing into the one or more printed matters of when the latter is taken out from the paper receiving tray 161.

The computers 2-1 through 2-N has the same configuration as generally used known personal computers. The internet Fax apparatus 4 and the Fax machine 5 have the same configuration as generally used known Fax machines. Therefore, configurations thereof are not described in detail.

### First Embodiment

Subsequently, a first embodiment of the present invention is explained. In the following description, an inquiry process is explained that is carried out when a printed matter is missing from the paper receiving tray of the multifunctional apparatus.

For the purpose of facilitating the explanation functioning of this implementation example in a state where printed matters of a plurality of users are accumulated in the paper receiving tray 161 of the multifunctional apparatus 1, the users are categorized as follows:
User A: actually took out his/her printed matter together with the printed matter of user B from the paper receiving tray 161 and took them away.
User B: his/her printed matter is actually missing from the paper receiving tray 161.
User C: one or more users who are suspected of having taken out the printed matter of user B from the paper receiving tray 161, including user A.

When the user B comes to the installation site of the multifunctional apparatus 1 to take the printed matter and notices that his/her printed matter is missing from the paper receiving tray 161, the user B makes inquiries about the missing printed matter by carrying out the following operations at the multifunctional apparatus 1.

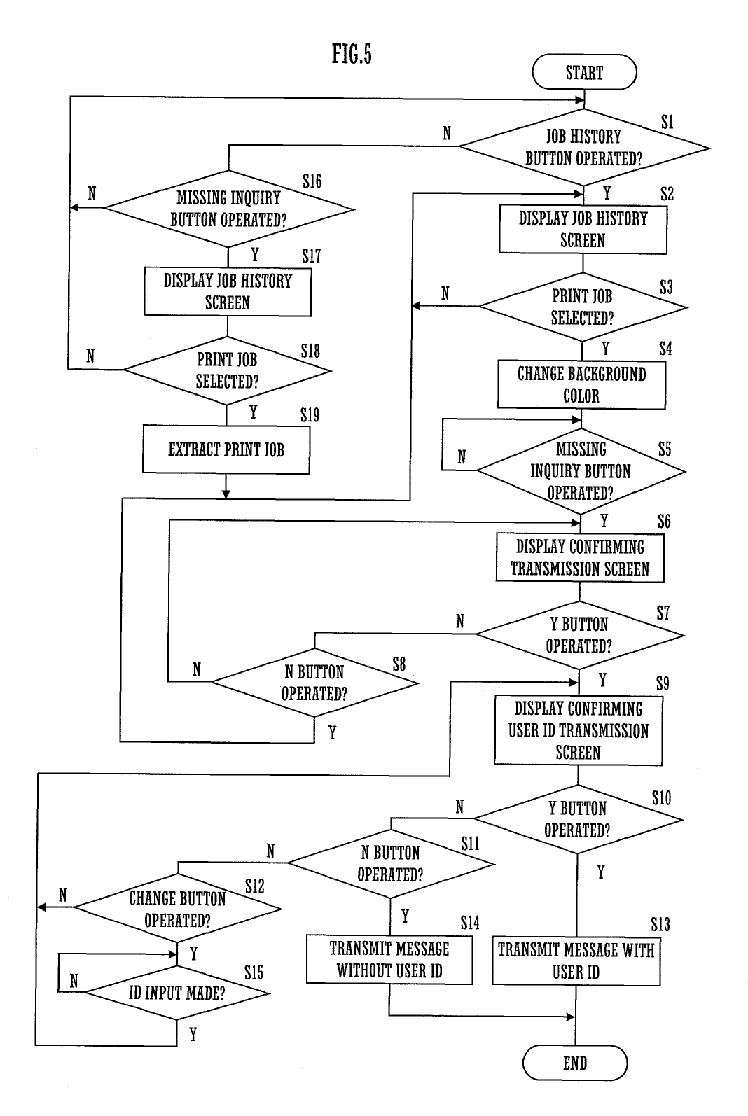

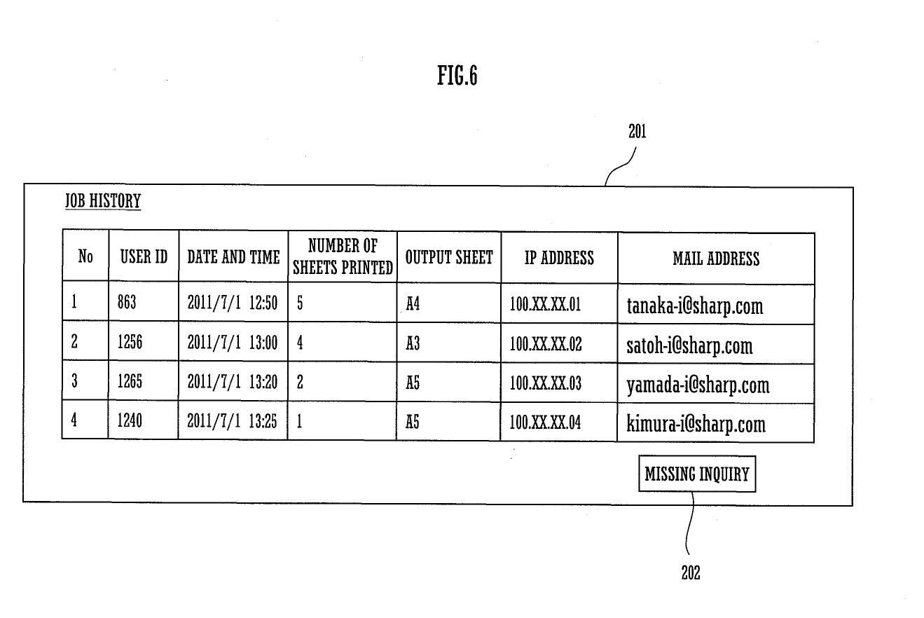

First, the user B operates the job history button 113 of the panel unit 9 shown in FIG. 4. As shown in FIG. 5, the control section 21, upon detecting the operation of the job history button 113 (S1:Y), reads out the data from the memory section 18, and causes the display panel 101 of the display section 10 to display a job history screen 201 as shown in FIG. 6 as a first display content (S2). Then, the control section 21 waits for a print job's being selected (S3:N).

On the job history screen 201 shown in FIG. 6 are displayed, as an example, receipt numbers of print jobs, ID's of a plurality of users who ordered runs of the print jobs, date and time when the print jobs were carried out, numbers of sheets printed, output paper sizes, IP addresses of the instruments that output the print jobs, and mail addresses that are contact addresses of the plurality of users who ordered the print jobs. At a lower right portion of the print job history screen 201, a missing inquiry button 202 is displayed.

Here, user names may be displayed in addition to the user ID's. It is also possible to display on the job history screen 201 kind of print job, namely whether the print job is printing, copying or fax.

These pieces of information displayed on the job history screen 201 can serve as reference data in selecting from the job history one or more print jobs of which runs were ordered by the user C who is or are likely to have taken away the missing printed matter. For example, when the print job is copying and the number of sheets printed is small, it is conceivable that the possibility of the printed matter's being taken away is low, because a user usually takes out a printed matter from the paper receiving tray 161 immediately after the copying is completed without leaving the place. Also, when the print job is printing or fax and the number of sheets printed is one, it is conceivable that the possibility of taking away another user's printed matter is either nil or very low.

The user B, touching the touch panel 118, selects from the job history screen 201 print job(s) by the user C who is(are) likely to have taken away the printed matter together. The number of print jobs selected may be either one or more.

Further, in a case where there are a small number of print jobs displayed in the job history screen 201, the user B, without selecting a print job, and considering all the displayed users as the user C based on information on the print jobs such as user ID's displayed on the job history screen 201 and/or the like, can make inquiries directly to the user C. In such a case, the job history screen 201 can be altered to a default screen by operating a clear button.

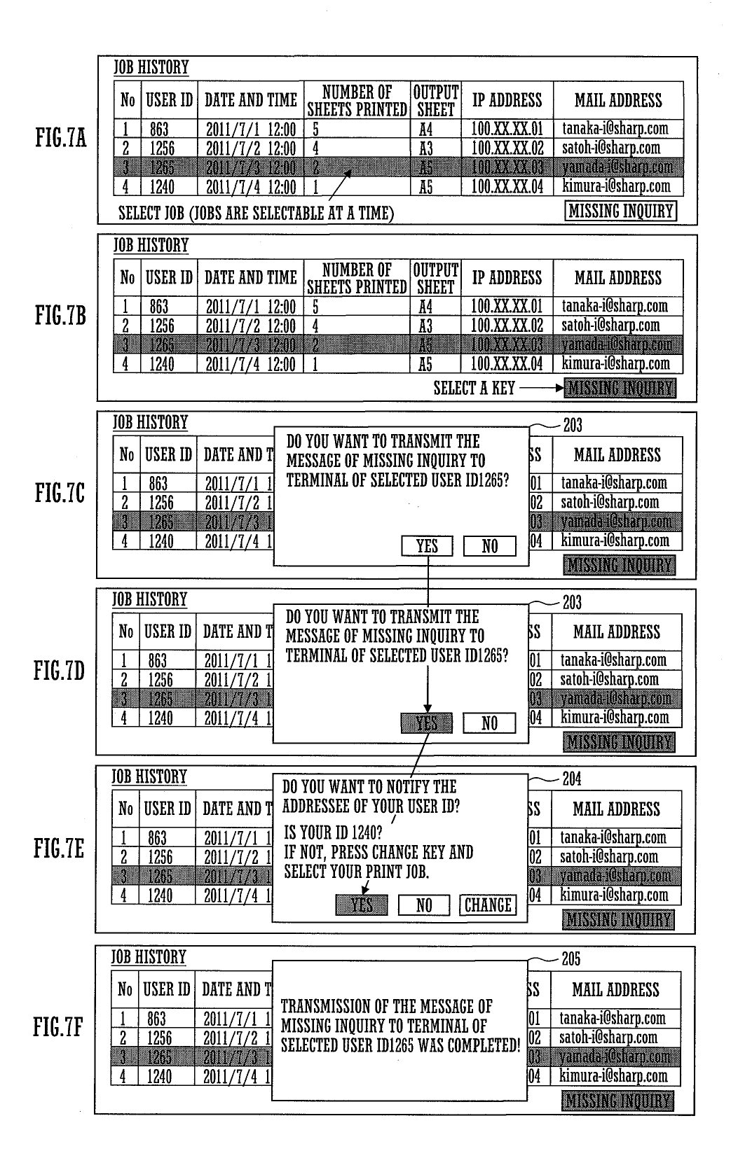

The control section 21, upon detecting that a print job has been selected (S3:Y) by a touch made on the touch panel 118, changes a background color of the selected print job (refer to S4, FIG. 7A).

Then subsequently, the user B, in order to transmit a message of missing inquiry to the user C who ordered the run of the selected print job, operates the missing inquiry button 202.

The control section 21, upon detecting the operation of the missing inquiry button 202 (refer to S5:Y, FIG. 7B), causes the display panel 101 to display a window 203 confirming transmission of the message of missing inquiry (refer to S6, FIG. 7C).

When the window 203 confirming the transmission is displayed on the display panel 101, the user B operates NO button if the message is considered not to be transmitted. The control section 21, upon detecting the operation of the NO button (S7:N, S8:Y), performs steps from the step S2 onward.

On the other hand, when transmitting the message, the user B operates YES button. The control section 21, upon detecting the operation of the YES button (refer to S7:Y, FIG. 7D), causes the display panel 101 to display a window 204 asking whether or not ID of the user B carrying out the missing inquiry is to be included in the message and confirming the ID of the user B when it is to be included (refer to S9:Y, FIG. 7E).

When the window 204 is displayed on the display panel 101, the user B get his/her ID displayed in the message, and operates YES button if the displayed ID is correct. The control section 21, upon detecting the operation of the YES button (refer to S10:Y, FIG. 7E), transmits the missing inquiry message including the user B's ID to a contact address of the user C who ordered the run of the selected print job (S13). Then, the control section 21 causes the display panel 101 to display a window 205 notifying that transmission of the message was completed as shown in FIG. 7F.

On the other hand, the user B operates NO button if his/her ID is considered not to be included in the message. The control section 21, upon detecting the operation of the NO button (S10:N, S11:Y), transmits the missing inquiry message (merely referred to as message, hereinafter) not including the user B's ID to the contact address of the user as destination who ordered the run of the selected print job (S14).

Moreover, if the displayed ID is incorrect and needs any change, the user B is required to operate a change button. The control section 21, upon detecting the operation of the change button (S11:N, S12:Y), displays an ID input screen (not shown) (S15:N). The control section 21, upon detecting an user ID (S15:Y), carries out steps from the step S9 onward again.

The destination to which the control section 21 transmits the message is a mail address of the user C, or a display screen of a terminal (the computers 2-1 through 2-N) the user C used.

[Mail]

When transmitting the message to a mail address of the user C, the control section 21 reads out from the memory section 18 the mail address as information on the terminal (computers 2-1 through 2-N) the user C used who ordered the run of the print job, and as information on the contact address of the user C. Then, the control section 21 produces a content described below as the message, and transmits a mail through the communications section 20.

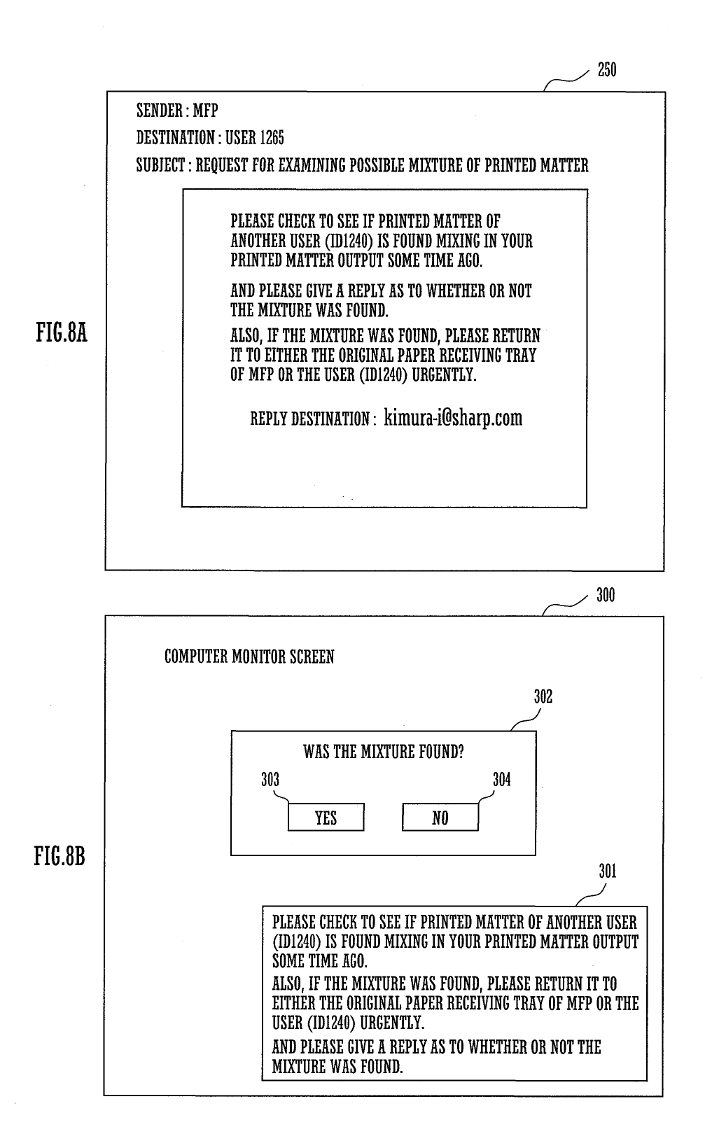

When the multifunctional apparatus 1 transmitted the message in the mail, the content (mail text) as shown in FIG. 8, for example, is displayed on the terminal (monitor screen 250) of the user C who received the mail.

Here, in this implementation example, configuration is set up in such a manner that the message shown in FIG. 8A is transmitted with the control section 21 of the multifunctional apparatus (MFP) 1 functioning as the origin of transmission of the mail. As shown in FIG. 8A, statements in the content indicating the user B's ID (ID1240 in the figure) includes:

1. User B's printed matter may be mixing in the printed matter taken out from the paper receiving tray 161.

2. Identification number (ID) of the user B (may be a name instead of ID).

3. Request for a reply as to whether or not the user B'S printed matter is found mixing, and the mail address of the user B.

4. Request for returning the user B's printed matter either directly to the above-mentioned user B or back to the paper receiving tray 161, if it is found mixing.

Here, lack of the indication of the user B's ID may be acceptable. In such a case, it has only to be notified that returning the user B's printed matter back to the paper receiving tray 161 is requested.

If the message has been transmitted in the mail, the user B can receive a reply to the message via a mail from the user C at the terminal (computers 2-1 through 2-N or mobile phone 61) the user B uses.

[Pop-Up Scheme]

The control section 21 transmits the missing inquiry message to a monitor screen 300 of the terminal (computers 2-1 through 2-N) the user C used. The missing inquiry message can be displayed by a pop-up scheme. Here, the pop-up scheme means a method to cause the terminal of the user C to display a pop-up window and to cause the window to display the message of missing inquiry.

In order for the message to be displayed according to the method, it is necessary to install beforehand a dedicated software (messenger software) for transmitting, receiving and displaying the message in the terminals (for example, computers 2-1 through 2-N, mobile phones 61) respective users use. When any of the computers 2-1 through 2-N is set as a destination, the multifunctional apparatus 1 reads out from the memory section 18 an IP address of the destination, and transmits the message data to the IP address. Here, to the message data is assigned a control number.

Any of the computers, upon receiving the message data from the multifunctional apparatus 1, displays a pop-up window 301 on the monitor screen 300. The message received is displayed in the pop-up window 301.

FIG. 8B is an example of the pop-up window. In the windows 301, the same content is displayed as in the case of the mail.

On the monitor screen 300 are also shown a pop-up window 302 including two buttons (YES button 303 and NO button 304) to reply as to the result of inquiries made about mixture of the printed matter, in addition to the windows 301. The control section 21, upon detecting that either of the two buttons 303, 304 has been operated by the user C, transmits to the multifunctional apparatus 1 the result of inquiries made as to whether or not the printed matter was taken away (mixing) as well as the aforementioned control number.

The user C who received a message examines the printed matter taken out from the paper receiving tray 161 based on the content of the message. When the printed matter of the user B is found mixing, the printed matter can be returned back to the paper receiving tray 161. Alternatively, when the user B's ID number is given in the pop-up window, the printed matter can be returned to the user B who is identified based on the ID number.

In the multifunctional apparatus 1, on receiving the reply from the user C to the message transmitted by the communications section 20 using the messenger software, the control section 21 causes the display panel 101 to display the result of inquiries made. The reply to the message includes a statement as to whether or not the user C took away the missing print job. The user B can check whether or not there is somebody among the user C who took away the missing printed matter through the job history screen 201 some time after completion of the transmission of the message of missing inquiry.

The control section 21, upon receiving the reply in the manner as described above, checks to see which message the reply is to based on the control number. Then, the control section 21 transmits the content of the received reply as a message to the computer the user B uses whose ID was identified or inputted in the steps S13, S15, using the messenger software or a mail. By checking the received message, the user B can examine the reply to the message without moving to the installation site of the multifunctional apparatus 1.

The user B having examined the reply to the message can respond in accordance with the content of the reply. For example, when the content of the reply is one that admits taking away of the missing printed matter, the user B can go to the user A (the user who actually took away the printed matter among the user C) who transmitted the reply and get the printed matter returned. Or, when none of the user C to whom the message was transmitted took away the printed matter, the user B, operating the operating section 11 (touch panel 118), can also transmit the message of missing inquiry to still other user(s).

In another implementation example, if the user B selects print jobs to transmit the message to whereas specific print jobs below are not included in the selected print jobs, the multifunctional apparatus 1 allows for a setting such that the specific print jobs are also automatically selected to transmit the message to. The specific jobs are, for example, print jobs of other user(s) carried out just before and just after the print job (of which printed matter is missing) of the user B. The print jobs of other user(s) are considered to be the print jobs of the user C, and are processed in the same manner as described above. Among the specific jobs are there a variety of patterns likely to cause taking away, and they can be set beforehand. A variation of the implementation makes it possible to perform such a control that considers automatically the user(s) of the aforementioned specific jobs to be the user C when there is no selection of a print job made by the user B within a predetermined time. Further, the user B, right after selecting a print job to transmit the message to, can also carry out confirming the transmission of the message to the users of the specific jobs.

Moreover, the user A (a user of the user C) who took away the printed matter is expected to operate the return-completed button 115 of the operating section 11, after returning the printed matter back to the paper discharge section 16 of the multifunctional apparatus 1. The control section 21 of the multifunctional apparatus 1, upon detecting the operation of the return-completed button 115, reads out information on a contact address of the user B from the memory section 18. Then, the control section 21, making use of the contact address of the user B as destination, notify, by a mail or by the messenger software, that the missing printed matter was returned.

Going to the installation site of the multifunctional apparatus 1 and examining the paper discharge section 16, the user B who received the notification can get the missing printed matter.

Further, in another implementation example, the control section 21 may be configured in such a manner that upon detecting the operation of the return-completed button 115 it transmits the message again to the user B by a mail or the messenger software. If the message is transmitted again, it is recommended for the message to notify that the missing printed matter was returned back to the paper discharge section 16.

Again, in yet another implementation example, the multifunctional apparatus 1 is capable of limiting the print jobs to display on the history screen when printed matters by a plurality of print jobs are accumulated in the paper receiving tray 161. What is required in order to limit the print jobs is to operate the missing inquiry button 114 instead of operating the job history button 113 in the step S1. In order to limit the print jobs, a sensor 171 detecting the presence of accumulation of the printed matters in the paper receiving tray 161 is used.

First, the control section 21, upon detecting the operation of the missing inquiry button 114 (S1:N, S16:Y), reads out data of the print jobs carried out in the past from the memory section 18, and causes the display panel 101 of the display section 10 to display the job history screen 201 shown in FIG. 6 (S17). Since the print jobs that have been carried out so far are indicated on the job history screen, limiting the print jobs to display from among these is what is to be done.

Touching the touch panel 118, the user B selects from the job history screen 201 the missing print job of which printed matter is missing from the paper receiving tray 161.

The control section 21, upon detecting an acceptance of the selection of the print job of which printed matter is missing through the user B's touching the touch panel 118 (S18:Y), extracts from the memory section 18 based on the output of the sensor 171 and displays print jobs corresponding to printed matters accumulated in the paper discharge section 16 ahead of and behind the missing printed matter produced by the print job (S19). The extracted print jobs give the above-mentioned limited print jobs. What permits such a limiting as in this manner is because only the print jobs concerning the printed matters accumulated together with the missing printed matter are considered to relate to the missing.

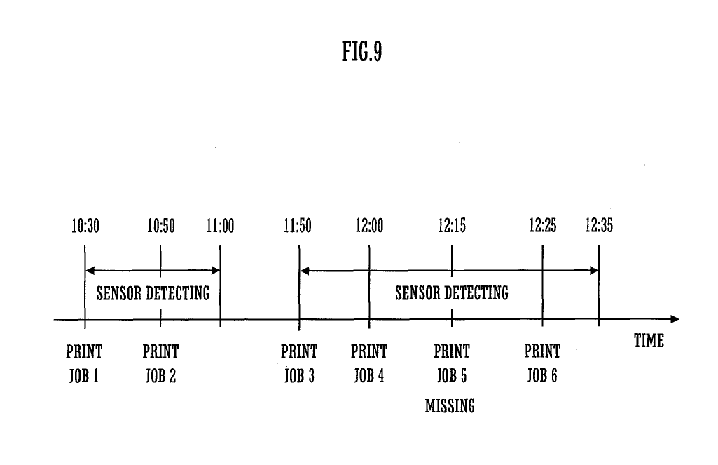

Shown in FIG. 9 is an example. In the diagram, the print job 5 shows the one carried out by the user B, and the printed matter by the print job is the one that is missing. Therefore, it is detectable from the output of the sensor 171 that the printed matters accumulated together with the missing printed matter were from the print job 3 to the print job 6. From the output of the sensor 171 (sensor output dropped off to ni1 at 11:00), it is understood that the print jobs 1 and 2 had been taken out. Therefore, it is conceivable that any of the users concerning the print jobs 3, 4, 6 took out the missing printed matter. Thus, the print jobs 3, 4, 6 are displayed as the limited print jobs (S19).

Further, in still another implementation example, the control section 21 is also capable of extracting print jobs satisfying printing conditions that concerns the missing print job from the history of respective print jobs the memory section stores and then causing the display panel 101 to display the extracted print jobs as a second display content.

As for the printing conditions that concern the missing print job, there are several conditions, for example, as follows:

1. When a printing condition of the missing print job specifies a printed matter consisting of a plurality of sheets, a print job of which printed matter consists of only one sheet is excluded.

When another user printed only one sheet of printed matter, it is hard to imagine that the user takes out more than one sheet of a printed matter and another printed matter from the paper receiving tray 161. Therefore, such a print job is excluded.

2. A print job specifying a sheet size smaller than the sheet size in the printing condition of the missing print job is excluded.

It is hard to imagine that another user takes out a printed matter of which sheet size is larger than the sheet size the user specified from the paper receiving tray 161. For example, when another user produced a printed matter of B5 size, it is hard to imagine that the user takes out printed matters of A4 size and B4 size together. Therefore, such a print job is excluded.

3. A print job specifying a sheet size not smaller than the sheet size in the printing condition of the missing print job is extracted.

It is conceivable that another user takes out a printed matter of which sheet size is not larger than the sheet size the user specified from the paper receiving tray 161. For example, when another user produced a printed matter of A4 size, it is conceivable that the user takes out printed matters of A4 size and B5 size together. Therefore, such a print job is extracted.

In the embodiment, it is considered that the printing conditions that concern the missing print job include timing conditions relating to the time when the printing of the missing print job was performed. Therefore, the following 4 and 5 are also regarded as the printing conditions.

4. A print job of which printed matter was produced just ahead of or just behind the print job of which printed matter is missing is extracted.

When another user takes out a printed matter accumulated just ahead of or just behind the missing printed matter from the paper discharge section 16, it is conceivable that the missing printed matter is also taken out mistakenly. Therefore, such a print job is extracted.

5. In a case where the print job (user B) of the missing printed matter was carried out between two different print jobs of the same another user (user C), the two different print jobs are extracted.

In the case where the user C ordered runs of two print jobs consecutively or within a predetermined time period, the user B's print job can be sandwiched in between depending on the timing. In such a case, it is conceivable that the user C takes out two printed matters from the paper receiving tray 161 without noticing that the user B's printed matter is sandwiched in between the two printed matters. Therefore, such print jobs are extracted.

The control section 21, upon extracting print job(s) based on predetermined conditions as described above, displays the extracted print job(s) on the job history screen 201 (S2). Then, it performs steps from the step S3 onward.

### Second Embodiment

Subsequently, a second embodiment of the present invention is explained.

When noticing that his/her printed matter is missing from the paper receiving tray 161 of the multifunctional apparatus 1, the user B can get the other print jobs displayed with ranks assigned thereto as explained below.

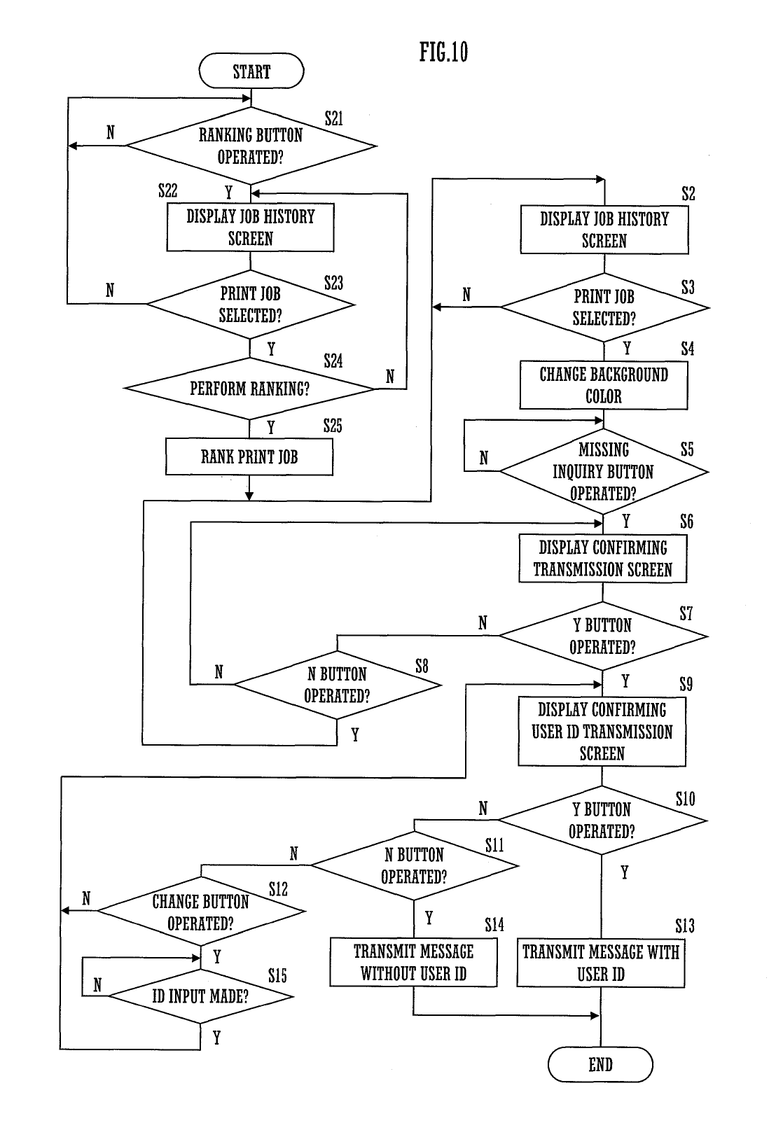

First, the user B operates a ranking button 116 on the panel unit 9 shown in FIG. 4. As shown in FIG. 10, the control section 21, upon detecting the operation of the ranking button 116 (S21:Y), reads out the data from the memory section 18, and then causes the display panel 101 to display the job history screen 201 shown in FIG. 6 (S22,S23:N).

The user B, touching the touch panel 118, selects the missing print job from the print jobs displayed on the job history screen 201 shown in FIG. 6.

The control section 21, upon detecting that the selection of the missing print job by the user B has been accepted (S23:Y), displays a screen asking whether to perform a ranking or not based on the printing conditions that concern the missing print job (S24). The control section 21, upon detecting that the user B's order to start the ranking has been accepted (S24:Y), reads out information on the print jobs performed in the past from the memory section 18, and then causes the display panel 101 to display the read out print jobs with the ranks assigned thereto (ranking) in such a manner as described below. The control section 21, for example, causes the display panel 101 to display the print jobs in descending order of ranks assigned thereto.

For the printing conditions that concern the missing print job, using the five printing conditions explained in the first embodiment is recommended. The print jobs that are deemed “to be excluded” as a result of satisfying some of the printing conditions that concern the missing print job in the first embodiment are considered in this embodiment “to be ranked at lower levels than the other print jobs” instead. Likewise, the print jobs that are deemed “to be extracted” as a result of satisfying some of the printing conditions that concern the missing print job in the first embodiment are considered in this embodiment “to be ranked at higher levels than the other print jobs” instead.

That is to say,

1. When the printing condition of the missing print job specifies a printed matter consisting of a plurality of sheets, print jobs of which printed matter each consists of only one sheet are ranked at lower levels than the other print jobs.

2. Print jobs each specifying a sheet size smaller than the sheet size in the printing condition of the missing print job are ranked at lower levels than the other print jobs.

3. Print jobs each specifying a sheet size not smaller than the sheet size in the printing condition of the missing print job are ranked at higher levels than the other print jobs.

4. A print job of which printed matter was produced just ahead of or just behind the print job of which printed matter is missing is ranked at a higher level than the other print jobs.

5. When the print job (user B) of the missing printed matter was carried out between two different print jobs of the same another user (user C), the two different print jobs are ranked at higher levels than the other print jobs.

Additionally, conditions to assign a rank to a print job may include a kind of the print job. For example, when the print job is copying and the number of sheets printed is small, it is conceivable that the possibility of the printed matter's being taken away is low, because a user usually takes out a printed matter from the paper receiving tray 161 immediately after the copying is completed without leaving the place. Therefore, when a print job is copying and the number of sheets printed is not larger than a predetermined number of sheets (5 sheets, for example), the print job is ranked at a lower level than printing and fax.

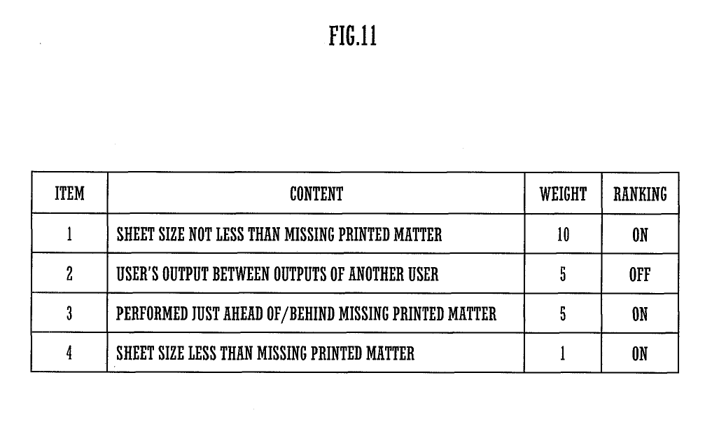

In this manner, when the ranking of print jobs is carried out based on a plurality of conditions as described above, it is recommended that each condition be given a weight as shown in FIG. 11. Then, to each print job a rank can be assigned based on the weight given to each.

For example, when a certain print job to rank was the one carried out just before the missing print job (weight 5) and its sheet size was larger than the missing printed matter (weight 10), a weight of 15 is given to the print job. And when another print job to rank was the one carried out just after the missing print job (weight 5) and its sheet size was smaller than the missing printed matter (weight 1), a weight of 6 is given to the print job. The control section 21 gives weights to print jobs in this manner, and causes the display panel 101 to display the print jobs in sequence of weight (descending order).

Here, the items of which ranking are set to ON in FIG. 11 show that they are the ones used as conditions when the ranking of the print jobs is carried out. On the other hand, the item of which ranking is set to OFF shows that it is the one not used as a condition when the ranking of the print jobs is carried out. The user B, by operating the operating section 11 beforehand, can select whether to use an item as a condition or not.

Each of the conditions above is stored in the memory section 18, and the control section 21, reading out the conditions from the memory section 18, assigns a rank to a print job.

In this manner, by performing a ranking to extracted print jobs, the user B, selecting print job(s) which the missing printed matter is likely to be mixing into the printed matter(s) of, can send the message of missing inquiry to the user C who ordered run(s) of the print job(s).

Further, in the multifunctional apparatus 1, it is also possible to limit print jobs before assigning ranks thereto, using the result detected by the sensor 171 as to the presence of printed matter(s) in the paper receiving tray 161, as explained based on FIG. 9. This makes it possible to reduce the number of print jobs to rank, thereby reducing a process time for ranking to a short time.

As shown in FIG. 10, the control section 21, upon completion of the ranking of the print jobs (S25), causes the display panel 101 to display the print jobs in descending order of assigned ranks on the job history screen 201 shown in FIG. 6 (S2). Then, the control section 21 waits for a print job's being selected (S3:N).

In this manner, displaying print jobs with ranks assigned thereto enable the user B to easily make selections when the print jobs are to be selected in order to transmit the message.

The control section 21, upon detecting that a print job has been selected (S3:Y) by a touch made on the touch panel 118, changes a background color of the selected print job (S4). From this onward, the control section 21 performs the respective processes in the same manner as the first embodiment explained based on FIG. 5, and transmits the message to the user C to examine whether or not the printed matter has been taken out properly from the paper receiving tray 161.

Additionally, the control section 21, upon receipt of the message by a mail or the messenger software, performs the same process as the first embodiment, and transmits a predetermined message to the contact address of the user C as destination.

In the multifunctional apparatus 1, a setting is possible that enables the control section 21 to transmit the message to the user C who ordered runs of high-rank print jobs (three highest-rank print jobs, for example) automatically after having performed the ranking of print jobs in the step S25. This can serve to simplify the user B's inquiry task to carry out when the printed matter is missing.

Further, in the step S3, in the cases where there are a small number of print jobs displayed on the job history screen 201, the user B can, instead of selecting print jobs, make inquiries directly to the User C, regarding all the users of the user ID's as the user C based on the information on the print jobs such as user ID's displayed on the job history screen 201 and so forth. In this case, the job history screen 201 can be altered to the default screen by operating the clear button.

In this manner, with the multifunctional apparatus 1, the user B whose printed matter is missing can easily carry out an inquiry task to the user C who is (are) likely to have taken out the printed matter of the user B from the paper receiving tray 161 even when the missing printed matter occurs when printed matters by print jobs of a plurality of users are accumulated in the paper receiving tray 161. Moreover, with the multifunctional apparatus 1, unlike the conventional image forming apparatus, it is not necessary to install a box with cover, so that the apparatus is not upsized, and thus the increase of installation area of the multifunctional apparatus 1 is restrained.

What is claimed is:

1. An image forming apparatus comprising:
an image forming section performing each print job ordered at each terminal connected through a network and thereby producing a printed matter of each print job;
a paper discharge section sequentially accumulating the respective printed matters produced by the image forming section allowing accumulated printed matters to be taken out freely;
a memory section storing each of the print jobs performed by the image forming section and information on each of the terminals having ordered a run of each of the print jobs associating the former with the latter;
a display section displaying a history of the respective print jobs stored by the memory section as a first display content;
an operating section accepting a selection of any print job from the history of the respective print jobs displayed on the display section; and
a control section reading out from the memory section information on a terminal corresponding to said any print job of which selection has been accepted by the operating section and therewith transmitting a predetermined message making use of a contact address of a user as destination who has ordered a run of said any print job using the terminal.

2. The image forming apparatus as claimed in claim 1 wherein the message includes a first message examining whether or not a printed matter has been taken out properly from the paper discharge section.

3. The image forming apparatus as claimed in claim 2 wherein the message further includes a second message requesting for returning the printed matter if the printed matter has been taken out improperly.

4. The image forming apparatus as claimed in claim 3 wherein the second message is a message requesting for returning the printed matter back to the paper discharge section if the printed matter has been taken out improperly.

5. The image forming apparatus as claimed in claim 2 wherein the message further includes a third message describing information on identification of a user.

6. The image forming apparatus as claimed in claim 2 wherein:
the message includes a fourth message stating that the printed matter has been returned back to the paper discharge section;
the operating section is provided with a function to accept an input of return-confirmed information that the printed matter has been returned back to the paper discharge section after a transmission of the first message; and
the control section transmits the fourth message to the destination if the return-confirmed information is inputted at the operating section.

7. The image forming apparatus as claimed in claim 2 wherein the display section, upon the control section's receiving a reply to the first messages after a transmission of the first message, displays the reply.

8. The image forming apparatus as claimed in claim 1 wherein the number of said any print jobs capable of being accepted by the operating section is plural.

9. The image forming apparatus as claimed in claim 1 wherein the display section, upon the operating section's selecting a missing print job of which printed matter is missing from the paper discharge section from the history of the respective print jobs stored by the memory section, and therewith upon extracting one or more past print jobs satisfying printing conditions that concern the missing print job, further displays the one or more past print jobs as a second display content.

10. The image forming apparatus as claimed in claim 9 comprising a detecting section detecting whether or not an accumulation of each printed matter is present in the paper discharge section, wherein the display section, upon the operating section's accepting a selection of the missing print job, and therewith extracting one or more print jobs from the memory section based on the output of the detecting section that correspond to printed matters accumulated in the paper discharge section ahead of and behind the missing printed matter produced by the missing print job, displays the one or more extracted print jobs.

11. The image forming apparatus as claimed in claim 1 wherein the destination is an e-mail address of the user.

12. The image forming apparatus as claimed in claim 1 wherein the destination is a display screen of the terminal the user has used.
